(19) United States
(12) Patent Application Publication
(10) Pub. No.: US 2017/0338726 A1
(43) Pub. Date: Nov. 23, 2017

(54) POLYPHASE MOTOR HAVING AN ALTERNATION OF PERMANENT MAGNETS AND SALIENT POLES

(71) Applicant: MMT SA, Zug (CH)

(72) Inventors: Pierre GANDEL, Montfaucon (FR); Mathieu AUBERTIN, Chemaudin (FR); Stéphane TAVERNIER, Besançon (FR); Stéphane BIWERSI, Frambouhans (FR)

(73) Assignee: MMT SA, Zug (CH)

(21) Appl. No.: 15/520,871

(22) PCT Filed: Oct. 23, 2015
(86) PCT No.: PCT/EP2015/074565

§ 371 Date: Apr. 21, 2017

(30) Foreign Application Priority Data
Oct. 23, 2014 (FR) 1460195

(51) Int. Cl. H02K 21/16; H02K 29/03; H02K 1/14; H02K 1/27

(52) U.S. Cl. CPC H02K 21/16; H02K 1/278; H02K 29/03; H02K 1/146; H02K 1/2746; H02K 2213/03

(57) ABSTRACT

A polyphase electric motor includes a stator having at least three coils and made up of 12.K radially extending teeth, and a rotor having 5.K pairs of magnetic poles, K being equal to 1 or 2. The rotor includes a core made of a ferromagnetic material and has an alternation of 5K magnetized poles, and 5K non-magnetized salient poles. The stator has teeth with rectangular or trapezoidal cross-sections converging towards the center of the motor.

### CROSS-REFERENCE TO RELATED APPLICATIONS

This application is a National Phase Entry of International Patent Application No. PCT/EP2015/074565, filed on Oct. 23, 2015, which claims priority to French Patent Application Serial No. 1460195, filed on Oct. 23, 2014, both of which are incorporated by reference herein.

### TECHNICAL FIELD

The present invention relates to the field of polyphase motors intended among others for such applications as valve lift in combustion engines, which require high torque densities (typically a few newtonmetres) and speeds typically of several thousand revolutions per minute.

### BACKGROUND

Motors having alternating magnets and salient poles, whose rotor comprises only one permanent magnet per pole pair, are known in this field. For example, U.S. Patent Publication No. 2010/148612 describes a brushless motor including magnetic poles arranged to all have the same polarity. The rotor includes gaps forming a magnetic resistance at the circumferential ends of each of the magnetic pole portions so that an iron core portion is formed between the adjacent magnetic pole portions. The magnetic flux of the magnetic pole portions passes through the iron core portion along the radial direction. The gaps include a first gap located on the leading end of the magnetic pole portion in the rotation direction of the rotor and a second gap located on the trailing end of the magnetic pole portion in the rotation direction of the rotor. The circumferential width of the first gap is set to be greater than the circumferential width of the second gap.

As another example, U.S. Patent Publication No. 2010/0133939 describes yet another example of a motor comprising a stator and a rotor. The rotor includes a first unit and a second unit. The first and second magnets are disposed alternately along a circumferential direction of the rotor at equal angular intervals to form magnetic pole portions. The number of magnetic pole portions of the second unit is the same as the number of magnetic pole portions of the first unit. The third magnet and the magnet of the first unit, having the same pole as the third magnet, are aligned in the axial direction of the rotor.

The present state of the art teaches the production of stator poles having tapered shapes on the inside, near the rotor. This conventional technique particularly aims to smooth out currentless loads and to minimize the variable reluctance component introduced by the protrusion on the rotor.

However, the use of tapered stator poles has significant drawbacks. In particular, it limits the winding volume that can be installed, thus considerably reducing the motor torque that can be achieved for any given electrical power. Moreover, it makes it more difficult to mount the coils since the winding must be carried out in situ taking care to follow the space reserved for the coils. Automating the process therefore is difficult. One of the problems that tapered poles introduce also is the greater quantity of magnetic flux that the poles collect on the whole, which leads to magnetic saturation and hence more significant losses during operation.

### SUMMARY

The object of the invention is to provide a motor structure that allows for a high space-to-power ratio and for smooth operation, thanks to the use of straight or rectilinear stator poles (whose cross-section, i.e. according to a plane that is perpendicular to the axis of rotation, is rectangular or trapezoidal), which is contrary to the teachings of the state of the art when salient rotor poles are used and the number of stator poles is low, typically amounting to 12 or 24 stator teeth. The results obtained with motors having 12 or 24 stator poles and 5, or respectively, 10 rotor pole pairs show an unexpected improvement compared to motors of the state of the art.

The advantages that the invention allows are mainly the following:
variable reluctance torque of negligible amplitude, thus reducing the impact of this component on the overall torque;
torque with sinusoidal current that facilitates its control and smooth motion;
currentless torque of negligible amplitude also contributing to smooth motion;
minimized phase inductance allowing for a motor according to the invention to be used for dynamic applications.

A motor topology according to the invention thus makes it possible to benefit from the effect of the salient poles (air gap is closed and thus magnetic flow is increased for a reduced magnet mass) without suffering from any negative effect due to the variable reluctance (negligible torque and not in opposition to torque with current), while preserving a good copper fill factor and an ease of realization. The motor constant, called Km (in newtonmetre per watt root) and representing the ratio of the motor torque to the square root of the electrical power dissipated by the coil (known as “Joules” power), is thus improved.

The use of straight poles (teeth) allows for the winding to be optimized, which guarantees an improved fill factor (ratio of actual copper volume to volume occupied by coil) compared to that which can be achieved in stators with tapered poles. The use of narrow poles, i.e. having an angular width at their inner end that is less than the polar half-pitch, particularly makes it possible to further improve the copper volume, and thus reduce the electrical resistance of the coil and increase the Km constant. In fact, with straight poles, the winding operation can be performed outside the motor with better yields than those obtained when winding on a stator (as is the case for motors with tapered poles), a yield that will be optimized when all or part of the stator teeth have a reduced angular width in relation to the polar half-pitch.

By way of non-limiting example, for a motor having an outer diameter of the order of 40 mm and an outer rotor diameter of the order of 25 mm, when applying the teachings of the present invention, the motor constant Km is improved by 30 to 40%, according to the coil fill factors achieved, compared to a prior motor. The topologies of the prior devices do not provide such advantages, particularly when used with five pole pairs. Specifically, the invention refers to a polyphase electric motor comprising a stator carrying at least three coils and consisting of 12.K radially extending teeth and a rotor having 5.K magnetic pole pairs, K being equal to 1 or 2, the rotor consisting of a core made of ferromagnetic material and having an alternation of 5K magnetic poles (with permanent magnetization) and 5K non-magnetic salient poles (without permanent magnetization) characterized in that the stator has teeth with a rectangular or trapezoidal cross-section converging towards the centre of the motor.

Embodiments may include the cases where the stator is inside the rotor or the case where the stator is outside the rotor. Throughout the text, a magnetic pole is either in the form of a magnet on the rotor surface, or in the form of one or several magnets buried in the rotor. In the latter case, the magnetic flux of the magnets is added to the vicinity in the rotor yoke to form a magnetic pole.

Advantageously, the stator has alternating wide and narrow teeth, the angular width of the wide teeth being at least twice as great as the angular width of the narrow teeth, preferably three times greater than the angular width of the narrow teeth. According to a particular embodiment, the angular width of the teeth is less than 15°/K, typically 13°/K. According to a variant, said core has 5.K longitudinal peripheral grooves in which said permanent magnets are housed. Preferably, said grooves have a width that is greater than the width of the permanent magnet.

According to a first method of implementation, the permanent magnet is bonded to the bottom of the groove. According to a second method of implementation, the permanent magnets are embedded, bonded or held by any mechanical means in the bottom of the groove. Advantageously, the magnets have a cylindrical outer surface.

According to a particular embodiment, the radial distance between the inner surface of the stator teeth and the outer surface of the permanent magnets is greater than the radial distance between the inner surface of the stator teeth and the outer surface of the non-magnetic salient poles. According to a variant, the angular width of the permanent magnets is greater than the width of the non-magnetic salient poles. In a particular embodiment allowing for the magnetic flux produced by the magnets to be increased, each pole pair on the rotor is formed by the alternation of a salient ferromagnetic pole and two parallelepiped-shaped magnets forming a V whose tip points towards the centre of the motor and each having a magnetization direction that is unidirectional and directed towards the inside of the V.

### BRIEF DESCRIPTION OF THE DRAWINGS

The present invention will be best understood when reading the following detailed description of non-restrictive exemplary embodiments, while referring to the appended drawings, wherein:

FIGS. 1a and 1b show cross-sectional views respectively of the stator and of the rotor of a motor according to a first variant of the invention;

FIG. 2 shows a diagram of the typical power supply of the coils;

FIG. 3 shows a cross-sectional view of a motor according to a second variant of the invention;

FIG. 4 shows the curve of the residual torque (without current) with a stator according to the state of the art and a stator according to the invention;

FIG. 5 shows the curve of the torque (with current) with a stator according to the state of the art and a stator according to the invention;

FIG. 6 shows the curves of the torque due to the variable reluctance according to the angular position, with a stator according to the state of the art and a stator according to the invention;

FIG. 7 shows an alternative embodiment of the rotor, which has D-shaped magnets;

FIG. 8 shows an alternative embodiment of the rotor, which has magnets and ferromagnetic poles of particular shapes;

FIG. 9 shows an alternative embodiment in which the rotor is outside the stator; and

FIG. 10 shows an alternative embodiment using several magnets configured in the form of a V to produce a magnetic pole.

### DETAILED DESCRIPTION

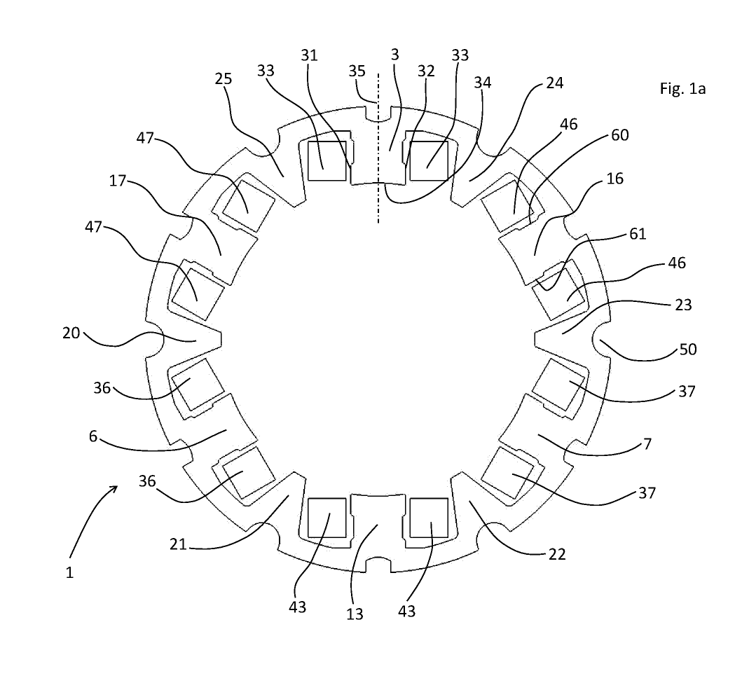

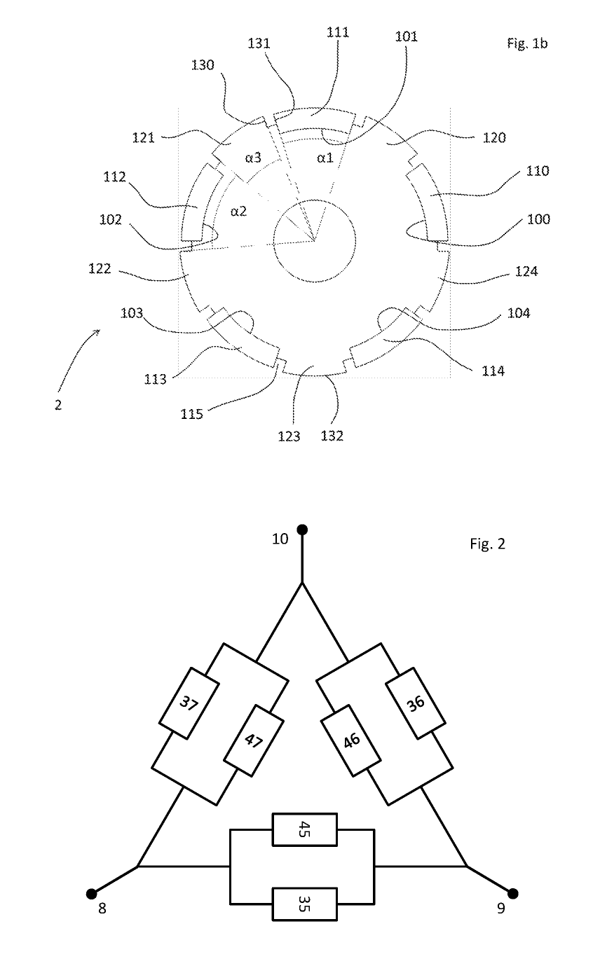

FIGS. 1a and 1b show cross-sectional views of a motor according to the invention, respectively an isolated view of the stator and an isolated view of the rotor. The motor comprises in known manner a stator (1) of cylindrical shape, which surrounds a rotor (2). The stator (1) is formed by a stack of cut metal sheets to have a configuration shown in the cross-sectional view of FIG. 1a.

Each metal sheet of the stator (1) has an alternation of 6 wide teeth (3, 6, 7, 13, 16, 17) and 6 narrow teeth (20, 21, 22, 23, 24, 25). In the example describing straight teeth, the wide teeth (3, 6, 7, 13, 16, 17) are delimited by two lateral edges (31, 32) that are parallel and symmetrical with respect to a radial axis (35). The front edge (34) of each tooth is curved inwards with a radius of curvature corresponding to the virtual cylindrical enclosure passing through the rotor-side inner surface of the teeth.

The angular width of the wide teeth (3, 6, 7, 13, 16, 17) is 20 degrees±2 degrees, and preferably 20 degrees. Each wide tooth (3, 6, 7, 13, 16, 17) is surrounded by an electric coil (33, 36, 37, 43, 46, 47). By way of non-limiting example, a coil typically comprises 36 turns of copper wire with a cross-section of 0.5 mm, for a motor supporting a continuous peak current of 30 amperes. The section of a coil is substantially square. The wide teeth (3, 6, 7, 13, 16, 17) have a narrow waist, with a middle portion (60) that is slightly smaller in cross-section than the base (61), to ensure that the core of the coil, which can be force-fitted, is braced. The difference in cross-section between the base (61) and the middle portion (60) is of the order of 8 to 12%. A middle portion (60) that is slightly larger in cross-section than the base (61) may also be produced to brace the core of the coil, the important thing being that a mechanical discontinuity is created, promoting retention.

Two opposite coils (33, 43) form an electrical phase. The coils of the same phase are connected in parallel, and the different phases are connected in delta connection, all phases being supplied at the same time, as shown in FIG. 2.

The opposite coils (33 and 43, 36 and 46, 37 and 47) are electrically connected in parallel, forming pairs, and each of the pairs corresponding to a phase. Each of the pairs is connected to one and to the other pair, to form a delta circuit. Each connection point (8, 9, 10) is supplied by a transistor bridge successively supplying each of the pairs of coils, directly for one of the pairs and in series for the other two pairs. Even though the delta electrical connection is shown here, any other conventional method of motor connection, particularly three-phase (star, delta, windings of the same phases being in series or parallel), may be considered.

The windings are placed onto the wide teeth (3, 6, 7, 13, 16, 17) when the motor is built, by sliding in a radial direction. The narrow teeth (20 to 25) are interposed between the wide teeth. The end of the narrow teeth has an angular width of 5 degrees±2 degrees, and preferably 5 degrees. Of course, in the case of a motor with 24 stator poles (not shown), the angular widths of the wide and narrow teeth are halved.

The cross-section of the narrow teeth (20 to 25) has a trapezoidal shape with lateral edges parallel to the lateral edges of the adjacent wide teeth. Splines (50) are provided at the base of certain narrow and/or wide teeth to allow the passage of locating pins into the stator. The rotor (2) is also formed by a stack of ferromagnetic sheets of generally disc-like shape and has alternating magnetic poles and salient poles. They have five peripheral grooves (100, 101, 102, 103, 104) which receive permanent magnets (110, 111, 112, 113, 114) in the form of a tile or with a D-shaped cross-section as shown in FIG. 7, as well as a ferromagnetic core (150).

In the example described in FIG. 1b, the magnets (110 to 114) are embedded in the rotor (2), with approximately 50% of the magnet's thickness penetrating into the rotor (2). These magnets (110 to 114) are united with the rotor (2) by bonding or any other conventional fixing means. Magnets with a plastic binder could be directly injected onto the stack of rotor sheets in a single step and the rotor thus formed could be magnetized.

The angular width of the magnets (110 to 114) is smaller than the angular width of the peripheral grooves (100 to 104). By way of example, the angular width α1 of the magnets (110 to 114) is 36 degrees±2 degrees, the angular width α2 of the peripheral grooves (100 to 104) is 45 degrees±2 degrees. The lateral edge (131) of the magnet defines, with the lateral edge of the groove (130), a magnetic separator (115) preventing the flux of the magnet from closing directly on itself through the rotor (2), without going through the stator (1).

The rotor (2) has salient ferromagnetic poles (120, 121, 122, 123, 124) between two permanent magnets. These salient ferromagnetic poles (120 to 124) have an angular width α3 of 27.3 degrees±2 degrees, i.e. less than the angular width of the permanent magnets (110 to 114). The outer edge (132) of the salient ferromagnetic poles (120 to 124) is curved inwards. The distance d between the inward curved surface (132) of the salient ferromagnetic poles (120 to 124) and the surface of the stator teeth is less than the distance D between the surface of the permanent magnets and the surface of the stator teeth by a factor of 2, typically 0.2 mm and 0.38 mm respectively.

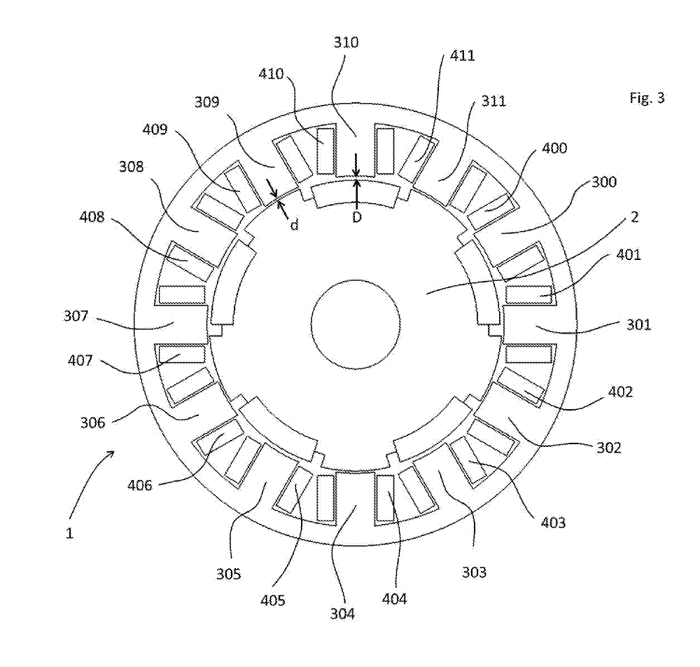

FIG. 3 shows an alternative embodiment of a motor according to the invention. The stator (1) comprises 12 teeth (300 to 311) extending in radial directions, all identical. They have a rectangular cross-section, with a rotor-side inner face that is curved inwards. The angular width of the teeth (300 to 311) at their inner end is 13°±2°, preferably 13°. Each of the teeth (300 to 311) is surrounded by a coil (400 to 411) comprising about twenty turns of copper wire. The rotor (2) is identical to that shown in FIG. 1b.

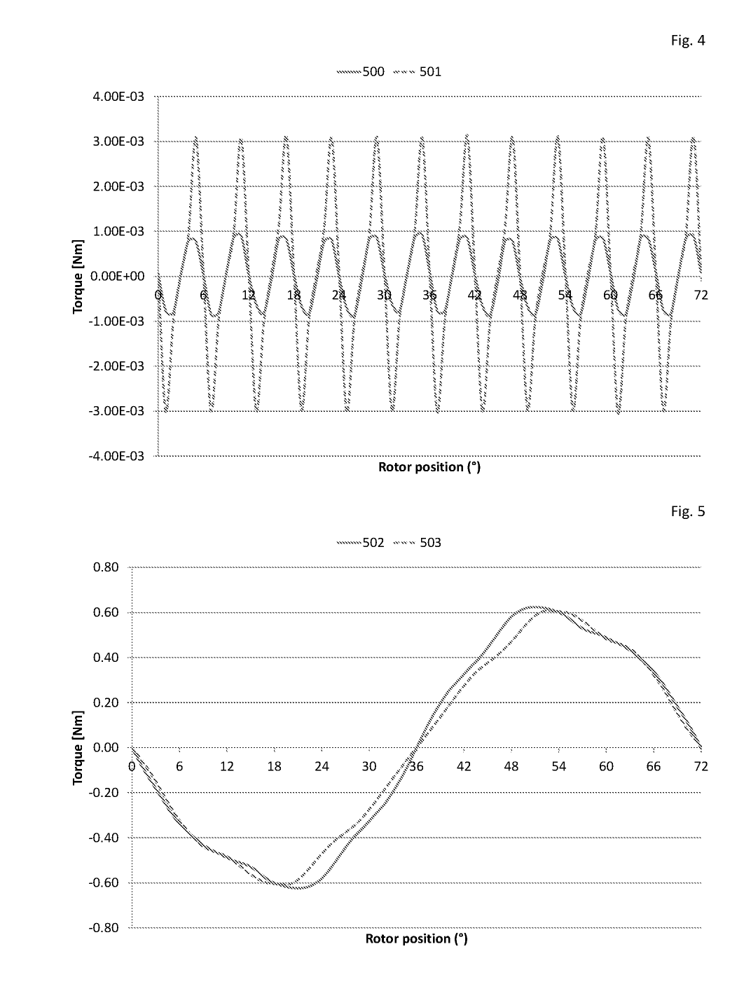

FIG. 4 shows the curves of the residual torque (without current) with a rotor having alternating magnets and salient poles, in the cases where there are five pairs of rotor poles and 12 stator poles, in comparison with a stator of the prior art with tapered poles. The curve (501) corresponding to a motor close to that of the invention, but different in that it includes a stator with tapered poles, reveals substantial variants of the currentless torque, as a function of the angular position of the rotor. This comparison of a motor according to the invention to a prior motor is interesting, because the choice of tapered poles is largely encouraged by the prior art and because the result of obtaining a currentless torque of lower amplitude when using a stator with straight poles was neither encouraged nor expected. For a motor according to the invention, with a stator with straight poles, it is observed that the currentless torque curve (500) is substantially minimized.

FIG. 5 shows the curves of the residual torque (with current and an identical number of ampere-turns) with a rotor having alternating magnets and salient poles, in the cases where there are five pairs of rotor poles and 12 stator poles, still in comparison with a prior stator with tapered poles. It is observed that the solution proposed by the invention results in a curve (502) close to the curve (503) obtained with a stator with tapered poles. Again, surprisingly, no deterioration of the torque in shape and amplitude is observed when straight poles are chosen. Thus, straight poles will allow for a greater amount of wound copper to be accommodated and thus enable the generation of a higher torque with constant electrical power. The phase inductance can also be reduced by using straight poles.

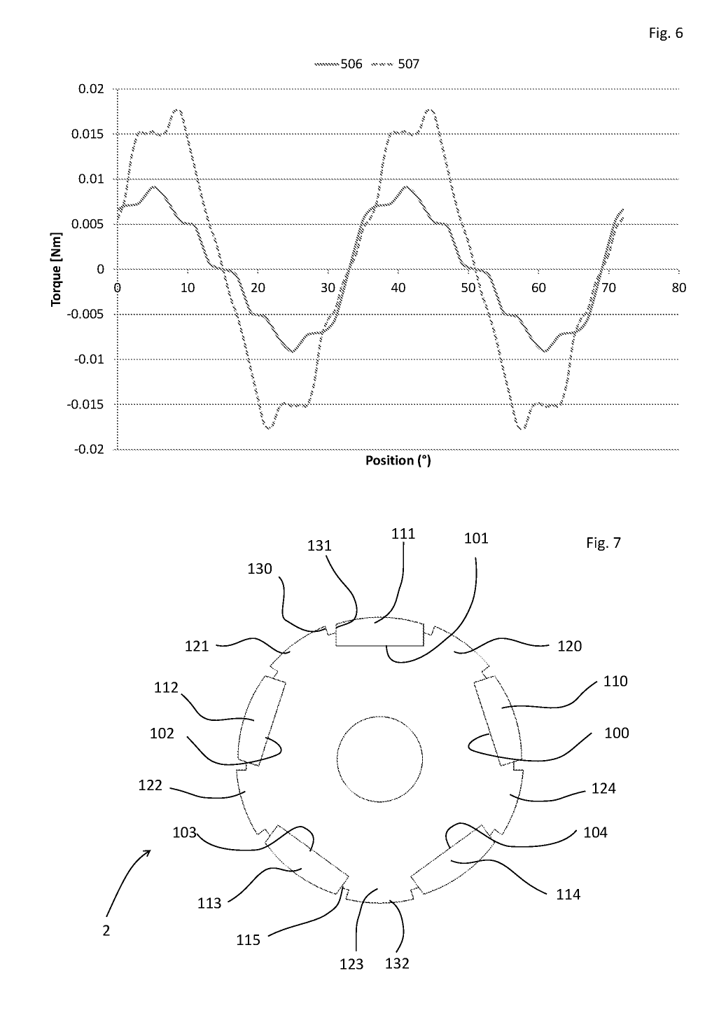

FIG. 6 shows the curves of the torque due to the variable reluctance as a function of the angular position, with a motor with tapered poles (curve 507) and a motor according to the invention (curve 506), both having an identical rotor with alternating magnets and salient poles. It is observed that the technical choices specific to the motor according to the invention allow to significantly reducing the torque due to variable reluctance, over the entire range of angular positions of the rotor, compared to motors of the prior art. Again, choosing a stator with straight poles, surprisingly, allows improving the performance of the prior motor. Alternating narrow and wide poles generally allow improving these observations and benefiting from greater smoothness of motion.

FIG. 7 shows a rotor according to the invention carrying tile magnets extending axially, with a D-shaped cross-section. In this embodiment, the base of the magnets, i.e. the inner surface, is plane and perpendicular to the radius.

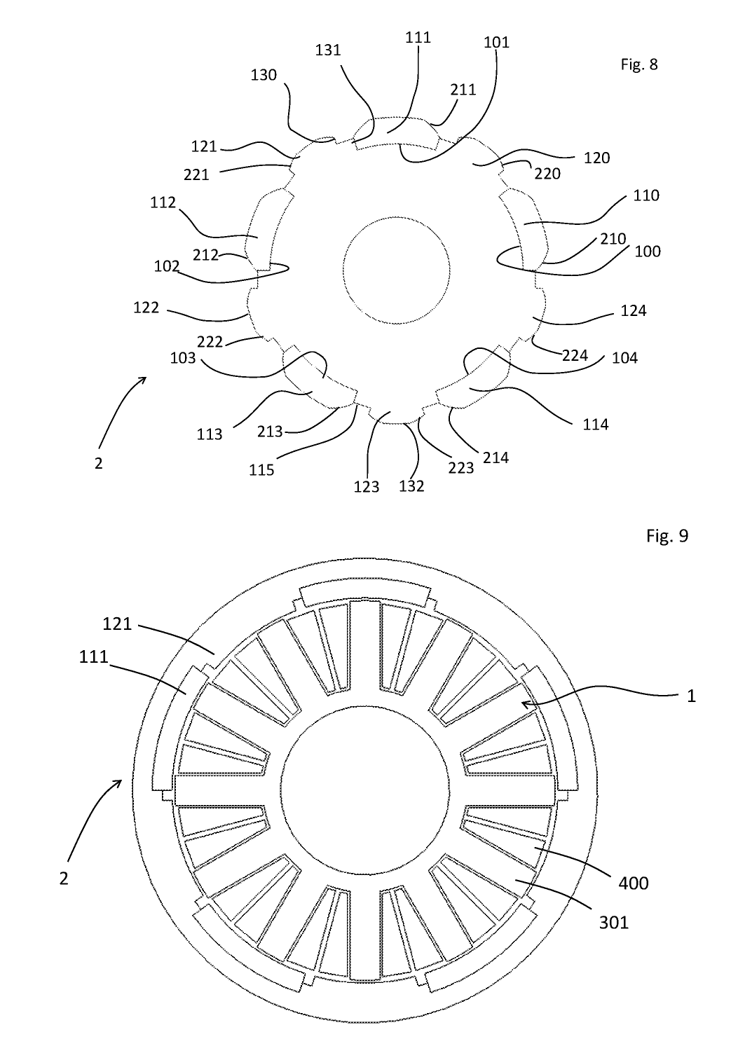

FIG. 8 shows a rotor according to the invention in a particular embodiment in which the rotor carries tile magnets whose outer edges have shapes (210, 211, 212, 213, 214) that allow increasing the distance between these edges and the inner face of the stator teeth. The rotor also carries ferromagnetic poles whose outer edges have shapes (220, 221, 222, 223, 224) that allow increasing the distance between these edges and the inner face of the stator teeth. The given shapes (210, 211, 212, 213, 214, 220, 221, 222, 223, 224) are typically chamfers or fillets, but may be of different shapes. These shapes are specifically given in order to, on the one hand, reduce the mass of magnet used, saving material and decreasing the inertia of the rotor, and, on the other hand, to adjust the shape of the torque with current. In fact, the shape given to the edges of the magnets and of the salient poles allow, in particular, making the torque with current more sinusoidal.

The present invention is not restricted to embodiments where the rotor of the motor is inside the stator. FIG. 9 shows a motor version in which the rotor (2) is outside the stator (1). The motor then has the same general characteristics as those described in the previous figures and particularly shows a stator (1) with 12 teeth of constant cross-section (301) extending from the centre of the motor. Here, each of these teeth (301) carries a coil (400). The rotor (2) outside the stator (1) has alternating permanent magnets (111) whose direction of magnetization can be radial or unidirectional.

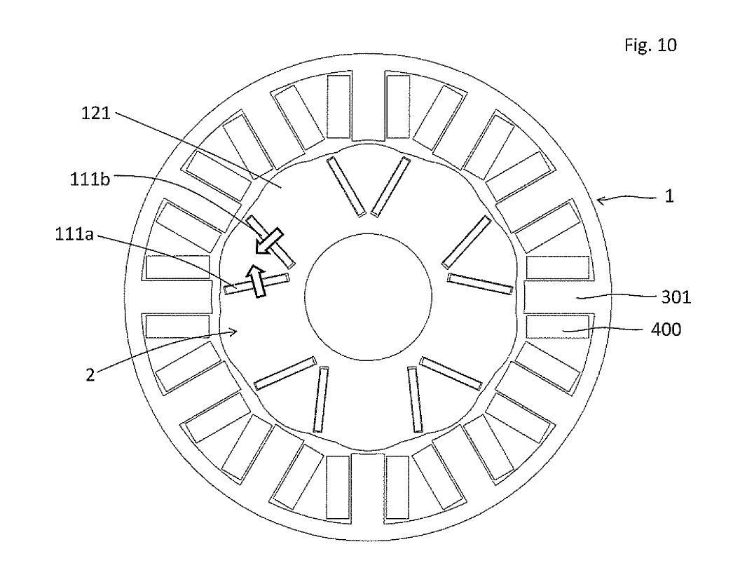

In order to increase the magnetic flux within the structure, thereby increasing the overall performance, placing two magnets to form a V may be considered and thus a pair of magnetic poles could be reproduced by alternating this magnetic V and a ferromagnetic protrusion. FIG. 10 shows an exemplary embodiment of such an internal rotor topology. Again, there is a stator (2) having teeth (301) of constant cross-section converging towards the centre of the motor and, here, each one carries a power supply coil (400). The rotor (2) has alternating ferromagnetic protrusions (121) and permanent magnets (111a) and (111b). These magnets (111a) and (111b) are in the form of parallelepiped blocks installed on the rotor to form a V whose tip points towards the centre of the motor, the direction of magnetization, symbolized by two thick arrows in FIG. 10, being unique for each magnet and directed towards the inside of the V in order to increase the overall magnetic flux. This topology thus enables flux concentration.

1. An electric polyphase motor comprising a stator carrying at least three coils, 12.K teeth extending radially and a rotor having 5.K pairs of magnetic poles, K being equal to 1 or 2, the rotor comprising a ferromagnetic material core and an alternation of 5.K magnetic poles and 5K non-magnetic salient poles, the stator including teeth of rectangular or trapezoidal cross-section converging towards a motor center.

2. The electric motor of claim 1 wherein the stator is inside the rotor.

3. The electric motor of claim 1 wherein the stator is outside the rotor.

4. The electric motor of claim 1 wherein the stator comprises alternating wide teeth and narrow teeth.

5. The electric motor of claim 4 wherein an angular width of the wide teeth is at least twice as great as the angular width of the narrow teeth.

6. The electric motor of claim 1 wherein an angular width of the teeth is less than 15°/K.

7. The electric motor of claim 1 wherein the magnetic poles are sectors of permanent magnets and the core has 5.K longitudinal peripheral grooves in which are housed the permanent magnets.

8. The electric motor of claim 7 wherein the grooves have a width greater than a width of the permanent magnet.

9. The electric motor of claim 7 wherein the permanent magnet is bonded onto a bottom of the groove.

10. The electric motor of claim 7 wherein the permanent magnets are embedded in a bottom of the groove.

11. The electric motor of claim 7 wherein the magnets have a cylindrical outer surface.

12. The electric motor of claim 1 wherein a radial distance between an inner surface of the stator teeth and an outer surface of the magnetic poles is greater than a radial distance between the inner surface of the stator teeth and an outer surface of the non-magnetic salient poles.

13. The electric motor of claim 1 wherein an angular width of the magnetic poles is greater than the non-magnetic salient poles.

14. The electric motor of claim 1 wherein each pole pair on the rotor is formed by alternation of a salient ferromagnetic pole and a magnetic pole in the form of two parallelepiped-shaped magnets forming a V whose tip points towards the motor center and each having a magnetization direction that is unidirectional and directed towards the inside of the V.
